(19) United States
(12) Patent Application Publication
(10) Pub. No.: US 2009/0065018 A1
(43) Pub. Date: Mar. 12, 2009

(54) Typically Spherical Applicator Tip For Application Of Cosmetic Products

(76) Inventor: Alain Berhault, Paris (FR)

Correspondence Address: BANNER & WITCOFF, LTD., TEN SOUTH WACKER DRIVE, SUITE 3000, CHICAGO, IL, 60606, US

(21) Appl. No.: 11/853,369

(22) Filed: Sep. 11, 2007

(51) Int. Cl. A45D 40/28; A45D 40/26; B29D 31/00

(52) U.S. Cl. 132/218; 132/320; 264/243

(57) ABSTRACT

The applicator tip comprises:
a) an application means comprising a rigid core and a plurality of flexible projections,
b) an axial handle member having an axial direction and comprising an upper end adapted to be fixedly connected to a rod, and operatively associated with the rigid core through its lower end, and characterized in that:
1) the applicator tip has, along the axial direction, a length L₀ ranging from 10 mm to 30 mm, application means having a length L₁ which ranges from 6 mm to 15 mm, wherein Lₒ=L₁+L₂,
2) the application means having a transverse width T, taken in a transverse plane, which is variable as a function of the axial distance L which varies from 0 to L₁, the function T=f(L) having a maximum value of T₁ for the transverse width when L is between 0.3. L₁ and 0.7. L₁.

### BACKGROUND OF THE INVENTION

(a) Field of the invention

The invention concerns the field of applicators for cosmetic products, typically make-up products for the eyes and lips.

(b) Description of Prior Art

A very large number of applicators of all kinds, in particular in the field of skin and eye care, and particularly of the eyes, with mascara applicators, are already known.

There applicators, which are adapted to operate jointly with a container defining a reservoir for mascara, typically comprise:
a) a cap adapted to seal the container and to be used as prehension means for the applicator,
b) and axial rod,
c) and a brush,
the rod being unitary with the cap at one of its ends, and with the brush at the other end thereof, the brush comprising a metallic twist on which a plurality of bristles are fixedly mounted.

With respect to the brush, a very large number of embodiments of brushes are already known.

Thus, the brushes described in the following French Patents are known: FR 2 505 633, FR 2 605 505, FR 2 607 372, FR 2 607 373, FR 2 627 068, FR 2 627 363, FR 2 637 471, FR 2 637 472, FR 2 650 162, FR 2 663 826, FR 2 668 905, FR 2 675 355, FR 2 685 859, FR 2 690 318, FR 2 701 198, FR 2 706 749, FR 2 715 038, FR 2 745 481, FR 2 748 913, FR 2 749 489, FR 2 749 490, FR 2 753 614, FR 2 755 593, FR 2 774 269, FR 2 796 531, FR 2 796 532, FR 2 800 586.

Also known are the brushes described in the following U.S. Patents: U.S. Pat. No. 4,733,425, U.S. Pat. No. 4,861,179, U.S. Pat. No. 5,357,987, U.S. Pat. No. 5,595,198, U.S. Pat. No. 6,241,411, U.S. Pat. No. 6,427,700.

Also known is French Patent FR 2 868 264 which, instead of brushes, discloses longitudinal applicators which are molded with plastic material and provide tips intended to be fixedly connected at one end of an axial rod, the other end being fixedly connected to a prehension means.

On the one hand, molded brushes and applicators of the prior art do not allow to provide all the make-up shades desired, with all the sharpness hoped for, since the face is all but a flat surface to be covered with a decorative or protective coating.

On the other hand, there is a need for new molded brushes and applicators in order to provide new make-up effects. Indeed, the possibilities of causing variation in the nature of molded brushes and applicators are dependent in particular on the known processes of manufacture.

Finally, in the field of make-up, there is a requirement for permanently renewing the offer of products by placing new products on the market in order to meet new needs or those which are not satisfied to this day.

### SUMMARY OF THE INVENTION

According to the invention, the applicator tip, adapted to be mounted at one so-called lower end of a rod of an applicator of cosmetic products, the other so-called upper end of the rod being unitary with a manual prehension means for the applicator, comprises:
a) an application means comprising a typically rigid core and a plurality of typically flexible projections, the plurality of projections being adapted to hold a portion of the cosmetic product when the applicator tip is dipped into the cosmetic product,
b) an axial handle member having an axial direction and comprising an upper end adapted to be fixedly mounted on the lower end of the rod through a fixation means, and operatively connected, through its lower end, with the core, the handle member and the core typically constituting a single-piece member, the assembled rod and axial handle member typically having the axial direction, and characterized in that:
   i) the core and the handle member constitute a plastic material molded part;
   ii) the application means comprises a plurality of N projections of plastic material, the plurality of projections and the molded portion typically constituting a single-piece molded member;
   iii) the applicator tip having, along the axial direction, a length L₀ ranging from 10 mm to 30 mm, the application means having a length L₁ ranging from 4 mm to 15 mm and the axial rod having a length L₂ ranging from 6 mm to 15 mm, wherein L₀=L₁+L₂;
   iv) the application means having a transverse width T, viewed in a transverse plane that is perpendicular to the axial direction, that varies as a function of the axial distance L ranging from 0 to L₁, the function T=f(L) having a maximum value T₁ for the transverse width when L is between 0.3. L₁ and 0.7. L₁.

The applicator tips according to the invention make it possible to solve the problems raised. Indeed, they have a geometrical configuration which is distinct, in particular through its shape and size, from those of the molded brushes and applicators of the state of the art, which makes it possible in particular to produce a great make-up sharpness even in the lesser accessible parts of the face.

According to a particularly preferred embodiment of the invention, the core is a core which substantially defines a truncated sphere with radius R, the truncation of the sphere corresponding to the junction between the core and the handle member. This rounded shape of the core advantageously makes it possible to obtain an applicator tip having a rounded surface of envelope without hollows that are too deep between the projections. As a matter of fact, hollows which are too deep could cause an accumulation of too much cosmetic product due to the fact that it is difficult to combine an applicator having a rounded surface of envelope with an efficient wiper. Thus, in view of the shape of this core, it is possible to obtain a rounded surface of envelope with projections of substantially identical sizes so that the properties of the projections, for example softness, are homogenous, which allows for a homogenous application of the cosmetic product.

### BRIEF DESCRIPTION OF DRAWINGS

FIG. 1a is a perspective view of an applicator tip according to the invention.

FIG. 1b is a side view of the same applicator tip.

FIG. 1c is an axial cross-section taken along line A-A of FIG. 1b.

FIG. 1d is a side view, on a true scale, of the applicator tip of FIG. 1a whose axial length L₀ is 16 mm.

FIG. 2a is a perspective view of another embodiment of applicator tip according to the invention, as a single-piece member.

FIG. 2b is a side view of the applicator illustrated in FIG. 2a.

FIG. 2c is an axial cross-section taken along axial plane A-A of FIG. 2b.

FIG. 2d is a side view, on a true scale, of the applicator tip of FIG. 2a whose axial length L₀ is 17 mm.

FIG. 2e is a transverse cross-section view taken along transverse plane B-B of FIG. 2b.

FIG. 2f is a transverse cross-section view taken along transverse plane C-C of FIG. 2b.

FIG. 3a is a side view of yet another embodiment of applicator tip according to the invention, as a single-piece molded member.

FIG. 3b is a partial axial cross-section view taken along line A-A of FIG. 3a.

FIG. 3c is a side view, on a true scale, of the applicator tip of FIG. 3a whose axial length L₀ is 18.2 mm.

FIG. 4a is a side view of yet another embodiment of applicator tip according to the invention, as a single-piece molded member.

FIG. 4b is another side view after 90° rotation of the applicator tip of FIG. 4a.

FIG. 4c is a front view of the applicator tip of FIG. 4a.

FIG. 4d is a cross-section view of an applicator provided with an axial rod which is unitary at its lower end with a tip according to the invention.

FIG. 5a is a side view of yet another embodiment of an applicator tip according to the invention, as a single-piece molded member.

FIG. 5b is a side view after 90° rotation of the applicator tip of FIG. 5a.

FIG. 5c is a front view of the applicator tip of FIG. 5a.

FIG. 6a is a lateral side view of the blank of an applicator tip according to the invention, expanded in longitudinal direction.

FIG. 6b is a lateral view from above of the blank of FIG. 6a obtained by 90° rotation of the blank of FIG. 6a.

FIG. 6c is a side view, similar to FIG. 1c, of the tip of FIG. 6a obtained by folding the blank along a median plane.

FIG. 7a is a partial lateral side view of a blank of an applicator tip according to the invention which is a variant of the blank of FIG. 6a.

FIG. 7b is a lateral view from above of the blank of FIG. 7a.

FIG. 7c is a partial view of a molded member obtained by folding the blank of FIG. 7a to define a tip as assembled at the end of a rod illustrated in dotted line.

FIG. 7d is a cross-section taken along transverse plane C-C of FIG. 7c.

FIG. 7e is a partial view from above of a blank with three arms.

FIG. 7f is a cross-section taken along plane E-E of FIG. 7e.

FIG. 7g which is similar to FIG. 7d, is a transverse cross-section view of the handle member of the molded member formed by folding the blank of FIG. 7e.

FIG. 7h is a partial view from above of a blank with four arms.

FIG. 7i is a cross-section view taken along plane H-H of FIG. 7h.

FIG. 7j is a transverse cross-section view of the handle member of the molded member formed by folding the blank illustrated in FIG. 7h.

### DESCRIPTION OF PREFERRED EMBODIMENTS

All the figures of the drawings relate to the invention.

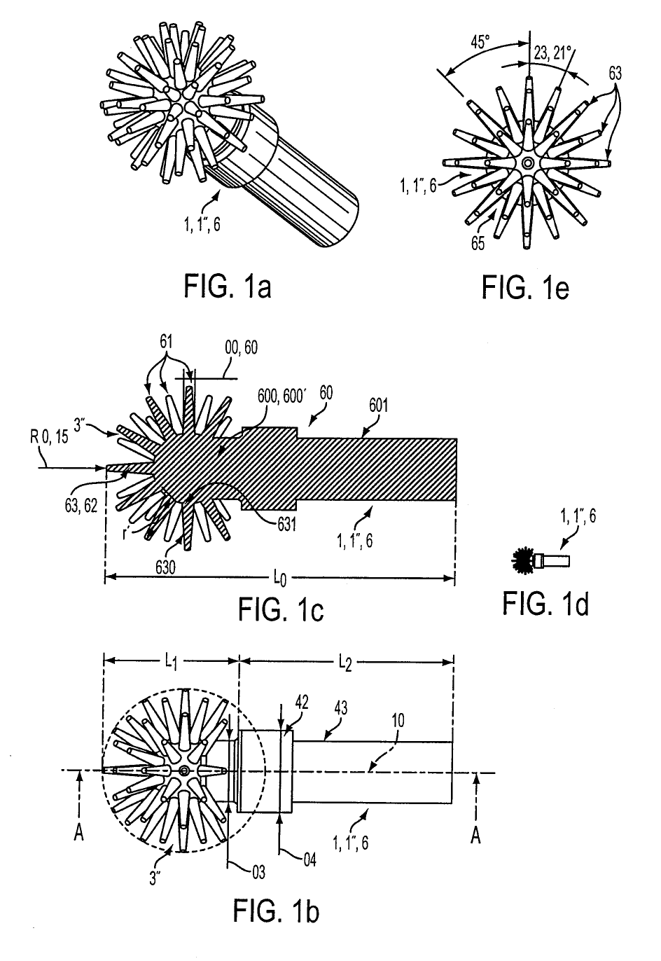

FIGS. 1a to 1e, 2a to 2f, 3a to 3c, and 4a to 4c relate respectively to four different embodiments of applicator tips 1,1″ constituting single-piece molded members 6.

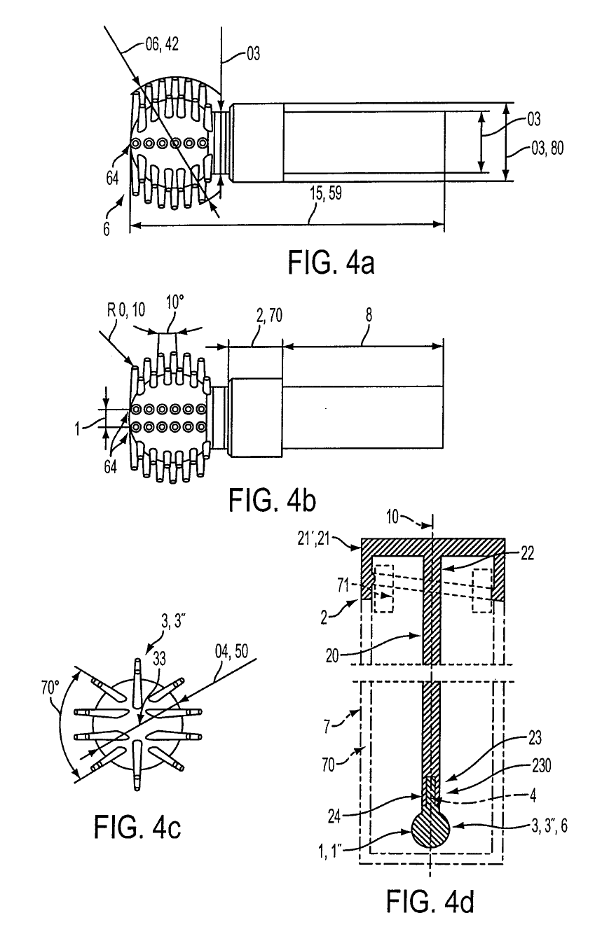

With reference to FIG. 4d it will be seen that there is illustrated an applicator 2 provided with an axial rod 20 which is unitary at its lower end 23 with a tip 1 according to the invention. On this Figure, there is schematically illustrated in dotted lines a container 70 which is typically associated with applicator 2 and contains the cosmetic product to be applied, in a manner to constitute a dispenser applicator 7. The neck 71 of such a container 70 is generally provided with a wiper (not illustrated in FIG. 4d).

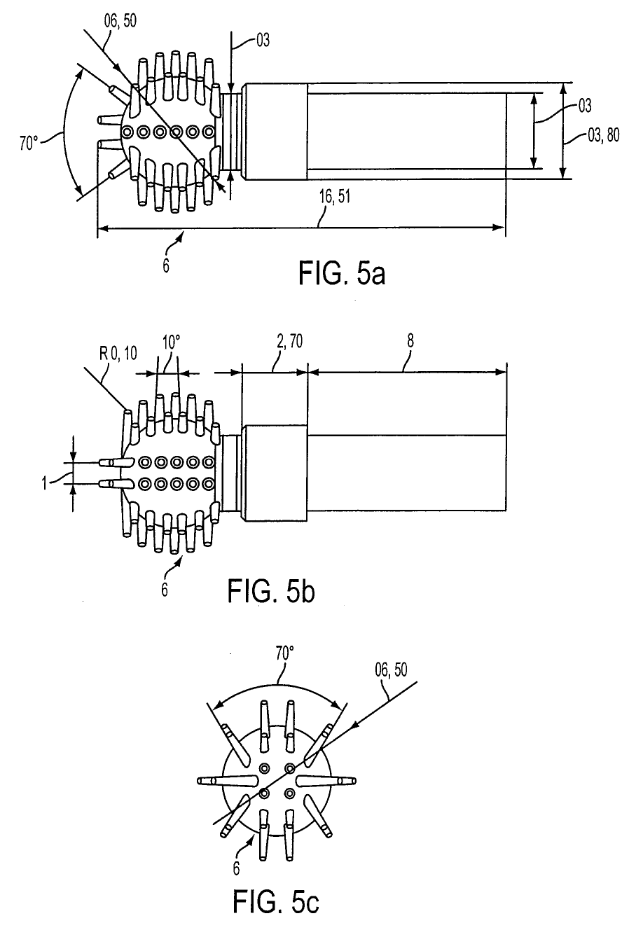

With reference to FIGS. 5a to 5c which are respectively similar to FIGS. 4a to 4c, it will be seen that they relate to another embodiment of applicator tip 1 defining a single-piece molded member 6.

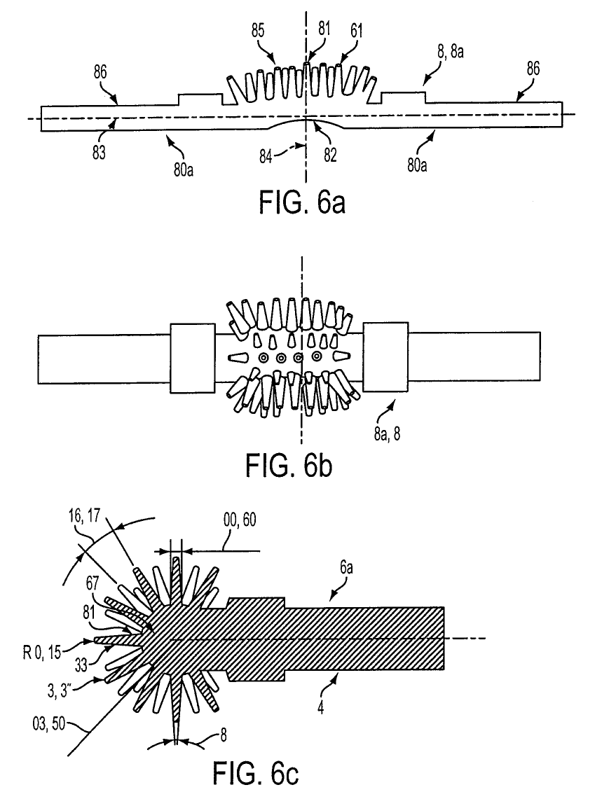

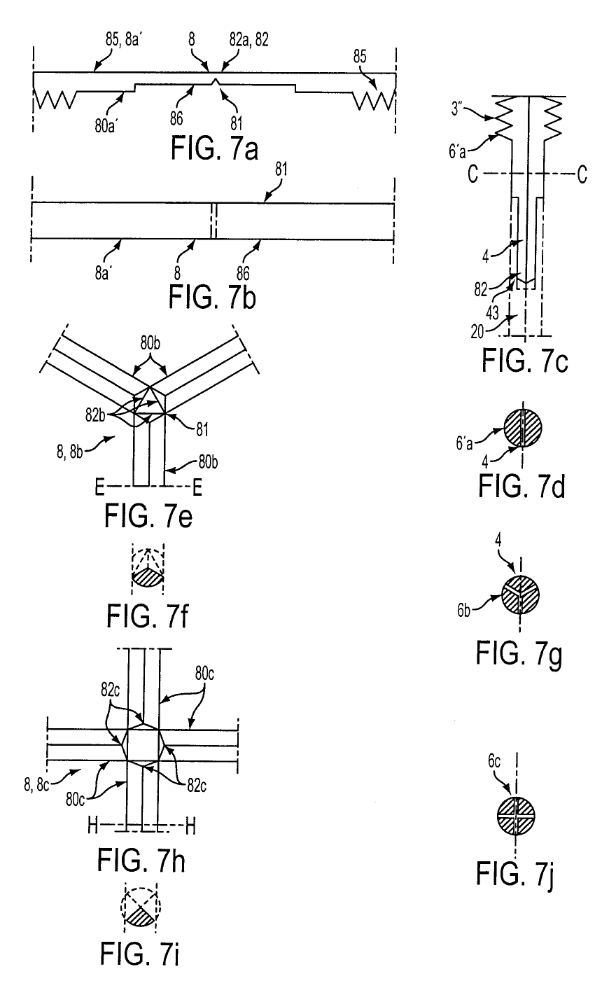

FIGS. 6a to 7j illustrate an embodiment of the production of an applicator tip 1,1″ defining a single-piece molded member 6 in which an expanded blank 8 is produced by molding, and the blank is folded upon itself to constitute single-pieced molded member 6.

FIGS. 6a to 6c illustrate the case of a blank 8,8a with two arms 80,80a. With reference to FIG. 6c it will be seen that tip 6,6a is obtained by folding blank 8,8a along a median plane 84 through a thinned down portion 82 of a central portion 81 defining a hinge. In this embodiment, the central portion 81 corresponds to portion 85 of the blank adapted to constitute the application means 3″ after folding.

FIGS. 7a to 7c schematically illustrate a variant of the production of FIGS. 6a to 6c, in which blank 8a is a blank 8a′ with two arms 80′ in which the flexible portion defining a hinge 82 is formed in portion 86 of the blank which is adapted to constitute the handle member 4.

With particular reference to FIG. 7c it will be seen that molded member 6a′ is obtained by folding the blank of FIG. 7a to define tip 1″ which has been illustrated at the end of rod 20, shown in dotted line.

FIGS. 7e to 7g relate to the case where blank 8 is a blank 8b with three arms 80b in which the central portion 81 comprises three thinned down portions 82b disposed as an isosceles triangle.

FIGS. 7h to 7j, which are respectively similar to FIGS. 7f to 7g, relate to the case where blank 8 is a blank 8c with four arms 80c in which the central portion 81 comprises four thinned down portions 82c disposed as a square.

According to the invention, the maximum value T₁ of the transverse width may be between 0.7. L₁ and 1.3. L₁.

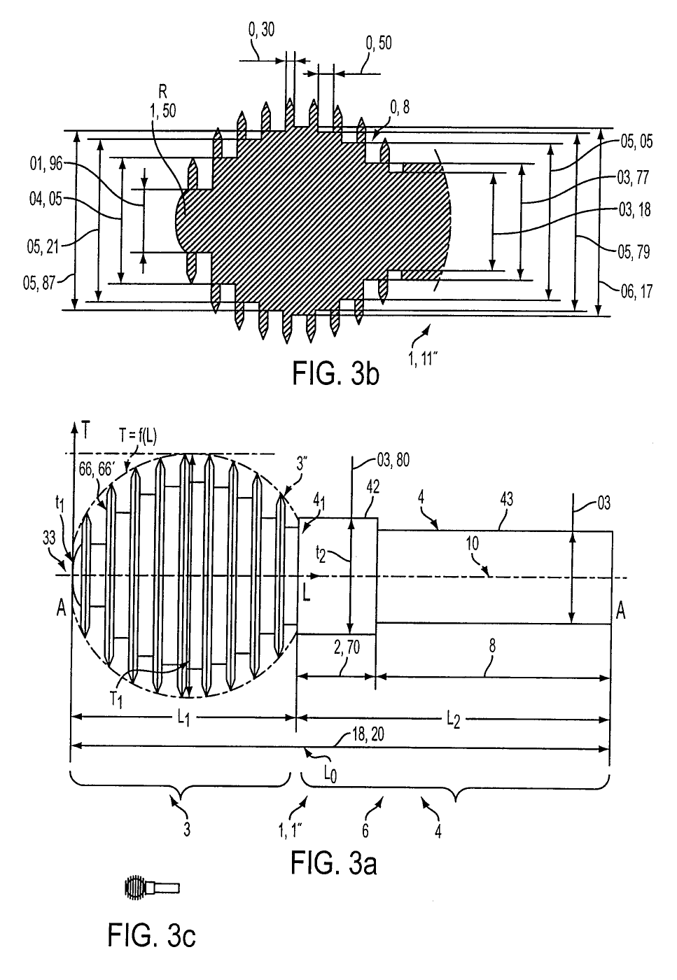

As can be seen particularly in FIG. 3a, the value of T₁ is near L₁, so that the application means 3,3″ has a surface of envelope corresponding substantially to a truncated sphere.

The function T=f(L) may have, at least in an axial plane comprising axial direction 10, a so-called first minimum value t₁ for L=0, L being taken as equal to 0 at the so-called lower end 33 of application means 3 and a so-called second minimum value t₂ for L=L₁, wherein L is taken as L₁ at the portion of the application means 3 adjoining the lower end 41 of handle member 4, the first minimum value t₁ being typically equal to 0, the second minimum value t₂ corresponding substantially to the transverse overloading of handle member 4, typically to its diameter D, so as to constitute a so-called “ball shaped” application means 3,3″.

According to an embodiment of the invention, and as illustrated for example in FIG. 1c, core 30 and handle member 4 may constitute a molded portion 60,600,601, which is typically rigid, and is made of plastic material, and application means 3 may be an application means 3″ comprising a plurality 61 of N projections of plastic material 62, the plurality 61 of projections and the molded portion 60 typically constituting a single-piece molded portion 6 made of at least one plastic material, so that tip 1 is a tip 1″ made of molded plastic material.

The projections 62 may be so-called radial projections 63 disposed perpendicularly with respect to the core.

The radial projections 63 may be of truncated shape, in which case each projection comprises a free end 630 and an end 631 that is unitary with core 600, the free end 630 having a transverse cross-section which is smaller than that of the end 631 which is unitary with core 600.

The application means 3″ may comprise N radial projections 63, wherein N ranges between 20 and 100, and typically between 30 and 80.

The radial projections 63 may have a length r′ which extends from 1.5 mm to 3.5 mm, typically from 2 mm to 3 mm, and preferably r′ is equal to 2.5 mm.

Core 600 may be a core 600′ constituting a substantially truncated sphere of radius R, the truncatio of the sphere corresponding to the junction of core 600′ and handle member 601.

As illustrated for example in FIG. 3a, handle member 601 may have a larger transverse dimension D, typically a diameter D, which typically ranges from 2 to 5 mm, and preferably from 2.5 to 4.5 mm.

As illustrated for example in FIGS. 4a and 4b, the radial projections 63 may constitute a plurality of axial alignments 64, the number of axial alignments 64 ranging from 5 to 15, and typically from 8 to 12.

The embodiment of tip 1,1″ of FIGS. 4a to 4c comprises 10 axial alignments, as this will appear in FIG. 4c.

As illustrated in FIG. 1e, the radial projections 63 may constitute a so-called hexagonal arrangement 65, each radial projection 63 being typically surrounded with six radial projections 63 symmetrically disposed at the vertices of a regular hexagon.

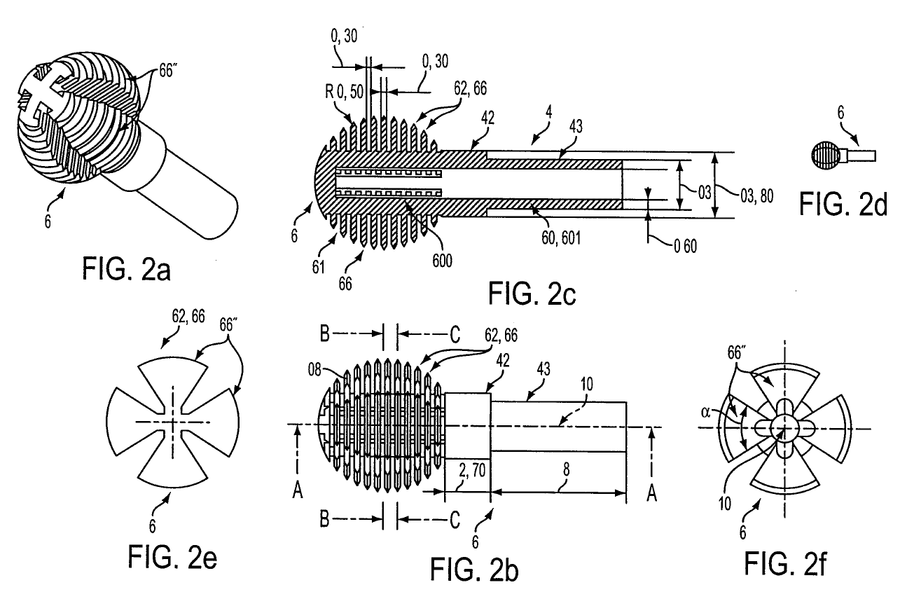

As illustrated in FIGS. 2a to 3c, the projections 62 may be so-called transverse projections 66, these transverse projections 66 being disposed in a plurality of n transverse planes which are typically perpendicular to the axial direction, in which case n varies between 5 and 20 and preferably between 8 and 15.

As illustrated in FIGS. 3a and 3b, the transverse projections 66 may be so-called circular projections 66′, each circular projection 66′ defining a typically flexible circular tongue which extends over 360°.

As illustrated in FIGS. 2a to 2d, each transverse projection 66 of a same transverse plane may typically comprise a plurality of N′ projections 66″ which are typically symmetrical with respect to axial direction 10, in which n′ is between 3 and 6, and is typically equal to 4.

Each projection 66″ may define an angular sector of angle α smaller than 360°/n′, as illustrated in FIG. 2f, wherein n=4.

As illustrated in FIG. 3a, handle member 4,601 comprises two portions of different cross-section: a so-called lower portion 42 having a transverse cross-section which typically approaches that of the rod, and a so-called upper portion 43 having a reduced cross-section, in a manner to be adapted to be operatively associated with rod 2 through its lower tubular end 230, typically by snapping or welding.

As illustrated in FIGS. 6a to 7j, in the process for manufacturing a tip according to the invention, a blank 8 of tip constituting a single-piece member may be produced by molding, typically by injection or injection-compression, the tip comprising n arms 80 which are articulated with respect to a central portion 81 comprising or constituting at least one hinge 82, in a manner to constitute the single-piece tip 6 by folding arms 80, wherein n typically varies from 2 to 4.

According to an embodiment illustrated in FIGS. 7a to 7j, the central portion 81 comprising or constituting at least one hinge 82 may be located at the upper end of the handle member.

The case of a blank 8,8a′ with two arms 80a′ has been illustrated in FIGS. 7a to 7d.

The case of a blank 8,8b with three arms 80b has been illustrated in FIGS. 7e to 7g.

The case of a blank 8,8c with four arms 80c has been illustrated in FIGS. 7h to 7j.

As illustrated in FIGS. 6a to 6c, the central portion 81 comprising or defining at least one hinge 82 may be located at the lower end 33 of the application means, and typically at the lower end 67 of the core 600 of the molded member.

Another object of the invention is provided by an applicator 2 for cosmetic products, typically mascaras, comprising an applicator tip 1,1″ according to the invention, the applicator 2 comprising a rod 20 typically having the axial direction 10, rod 20 being fixedly connected, at its so-called lower end 23, to the applicator tip 1,1″, and at its so-called upper end 22, to a means of manual prehension 21.

Such an applicator has been illustrated in FIG. 4d.

Another object of the invention is provided by a dispenser applicator 7 of cosmetic products, typically mascaras, comprising an applicator 2 according to the invention which is operatively associated with a container 70 adapted to contain the cosmetic product, the container 70 comprising a typically threaded neck 71, typically provided with a wiper, the typically exteriorly threaded neck 71 being operatively associated with the prehension means 21 constituting an interiorly threaded plug 21 to seal neck 71.

### EXAMPLES

I) Tips 1,1″ constituting single-piece molded members 6 of plastic material, according to FIGS. 1a to 5c, were manufactured by molding.

Tests were made with PE and with an elastomer, however any plastic material that can be molded for allowing to simultaneously constitute an axial handle member 4 which is relatively rigid to make sure that the tip 1 is fixedly mounted on rod 20 of applicator 2 and an application means 3,3″ comprising a plurality of relatively flexible projections 31, may be used.

To manufacture these tips by molding, the process described in FIGS. 6a to 7j was used, in particular whenever this was required by the stripping stresses.

I-1) The tip 1,1″ according to FIGS. 1a to 1e was produced.

This applicator tip has an axial length L₀ of 16 mm.

Its application means 3,3″ comprises a plurality of hexagonally arranged 65 projections 61. The core 600,600′ constitutes a truncated sphere 3.5 mm in diameter, the plurality of projections 61 lying in a truncated sphere 8 mm in diameter. The projections 61 are substantially truncated and have a base 631, 0.6 mm in diameter and a rounded end 630.

Its handle member 4 comprised an upper portion 43 3 mm in diameter adapted to be operatively associated with a blind hole formed at the end of the rod 20, as illustrated in FIG. 4d, and a lower portion 43, 4 mm in diameter.

I-2) In a similar manner, the tip 1,1″ according to FIGS. 2a to 2f was prepared.

In this tip, the core 600 and the handle member 4 are hollow, and the projections 31 define a plurality of transverse projections 66, each projection comprising four symmetrical projections 66″ forming sectors of angle a equal to about 60°.

I-3) In a similar manner, the tip 1,1″ according to FIGS. 3a to 3b was prepared.

In this case, the transverse projections 66 are circular transverse projections 66′.

I-4) In a similar manner, the tip 1,1″ according to FIGS. 4a to 4c was prepared.

In this tip, the plurality of projections 61 constitutes axial alignments 64-10 axial alignments.

I-5) In a similar manner, the tip 1,1″ according to FIGS. 5a to 5c, and which is closely similar to that of FIGS. 4a to 4a, was prepared. This tip has a lower end 33 which is free of projections 31.

These tips 1,1″ were assembled with rods 20 to constitute applicators 2, which are essential elements for dispenser applicators 7 of cosmetic products, in particular make-up products for the eyes, such as mascaras, or make-up products for the lips, or also for the nails.

In use, it was noted that these tips 1,1″ provided a fine sharpness of application. In addition, they made it possible to sample only a relatively limited quantity of cosmetic products, which appeared advantageous with respect to the service life of the distributor applicator and the stability in time of the cosmetic product.

### LIST OF REFERENCE MARKS

Applicator tip . . . 1,1″
   Axial direction . . . 10
Cosmetic product applicator . . . 2
   Rod of 2 . . . 20
   Manual prehension means of 2 . . . 21
   Threaded plug . . . 21′
   Upper end of 20 unitary with 21 . . . 22
   Lower end of 20 unitary with 21 . . . 23
      Tubular part operatively
      associated with 43 . . . 230
   Means 1 and 4 for cooperating with 20 . . . 24
Application means of 1 . . . 3
Application means of 6 . . . 3″
   Typically rigid core . . . 30
   Plurality of projections . . . 31
   Unitary projection of 31 . . . 32
   Lower end of 3, 3″ . . . 33
Axial handle member of 1 . . . 4
   Upper end of 4 operatively
   associated with 20 . . . 40
   Lower end of 4 operatively
   associated with 3 . . . 41
   Lower part operatively
   associated with 3 . . . 42
   Upper part operatively
   associated with 20 or 230 . . . 43
Single-piece molded member
constituting 1″ . . . 6
   Molded part constituting 30+4 . . . 60
      Portion of 60 defining core 30 . . . 600
      Core in shape of truncated sphere . . . 600′
      Portion of 60 constituting
      handle member 4 . . . 601
   Plurality of projections . . . 61
   Projection of 61 . . . 62
   Radial projection . . . 63
   Axial alignment of 63 . . . 64
   Hexagonal alignment . . . 65
   Transverse projection . . . 66
   Circular transverse projection . . . 66′
   Typically symmetrical projection . . . 66″
   Lower end of 6 . . . 67
Dispenser applicator . . . 7
   Container . . . 70
   Neck . . . 71
Blank of 1,1′,6 . . . 8
   Arm of 8 . . . 80, 80a, 80b, 80c
   Central portion . . . 81
   Thinned down portion defining hinge . . . 82, 82a, 82b, 82c
   Median plane of 8 . . . 83
   Longitudinal direction of expanded blank . . . 84
   Portion of 8 adapted to constitute 3′ . . . 85
   Portion of 8 adapted to constitute 4 . . . 86

What is claimed is:

1. Applicator tip (1), adapted to be mounted at one so-called lower end (23) of a rod (20) of an applicator (2) of cosmetic products, the other so-called upper end (22) of said rod (20) being unitary with a manual prehension means (21) for said applicator (2), comprising:
a) an application means (3) comprising a typically rigid core (30) and a plurality (31) of typically flexible projections (32), said plurality (31) being adapted to hold a portion of said cosmetic product when said applicator tip (1) is dipped into said cosmetic product,
b) an axial handle member (4) having an axial direction (10) and comprising an upper end (40) adapted to be fixedly mounted on said lower end (23) of said rod (20) through a fixation means (24), and operatively connected, through its lower end (41), with said core (30), said handle member (4) and said core (30) constituting a single-piece member, said assembled rod (20) and axial handle member (4) having said axial direction (10), and characterized in that:
i) said core (30) and said handle member (4) constitute a molded portion (60, 600, 601) of plastic material;
ii) said application means (3, 3″) comprises a plurality (61) of N projections (62) of plastic material, said plurality (61) of projections and said molded portion (60) typically constituting a single-piece molded member. (6);
iii) said applicator tip (1) having, along said axial direction (10), a length L₀ ranging from 10 mm to 30 mm, said application means (3) having a length L₁ ranging from 4 mm to 15 mm and said axial handle member (4) having a length L₂ ranging from 6 mm to 15 mm, wherein L₀=L₁+L₂;
iv) said application means (3) having a transverse width T, viewed in a transverse plane that is perpendicular to said axial direction (10), that varies as a function of the axial distance L ranging from 0 to L₁, the function T=f(L) having a maximum value T₁ for said transverse width when L is between 0.3. L₁ and 0.7. L₁.

2. Applicator tip according to claim 1, in which said maximum value T₁ of said tranverse width is between 0.7. L₁ and 1.3. L₁.

3. Applicator tip according to claim 1, in which said function T=f(L) has, at least in an axial plane comprising said axial direction (10), a so-called first minimum value t₁ for L=0, L being taken as equal to 0 at the so-called lower end (33) of said application means (3) and a so-called second minimum value t₂ for L=L₁, L being taken as L₁ on the part of said application means (3) adjoining the lower end (41) of said handle member (4), said first minimum value t₁ being typically equal to 0, said second minimum value t₂ corresponding substantially to the transverse overloading of said handle member (4), typically to its diameter D, so as to constitute a so-called “ball shaped” application means (3, 3″).

4. Applicator tip according to claim 1, in which said projections (62) are so-called radial projections (63) disposed perpendicularly with respect to said core.

5. Tip according to claim 4, in which said radial projections (63) are of truncated shape, in which case each projection comprises a free end (630) and an end (631) that is unitary with said core (600), the free end (630) having a smaller transverse cross-section than that of the end (631) which is unitary with said core (600).

6. Tip according to claim 4, in which said application means (3″) comprises N radial projections (63), wherein N ranges between 20 and 100, and typically between 30 and 80.

7. Tip according to claim 4, in which said radial projections (63) have a length r′ which ranges between 1.5 mm and 3.5 mm, typically between 2 mm and 3 mm, and preferably 2.5 mm.

8. Tip according to claim 4, in which said core (600) is a core (600′) constituting substantially a truncated sphere of radius R, the truncation of said sphere corresponding to the junction of said core (600′) and handle member (601).

9. Tip according to claim 8, in which said handle member (601) has a larger transverse dimension D, typically a diameter D, which typically ranges from 2 to 5 mm, and preferably from 2.5 to 4.5 mm.

10. Tip according to claim 4, in which said radial projections (63) constitute a plurality of axial alignments (64), the number of axial alignments (63) ranging from 5 to 15, and typically from 8 to 12.

11. Tip according to claim 4, in which said radial projections (63) constitute a so-called hexagonal arrangement (65), each radial projection (63) being typically surrounded with six radial projections (63) symmetrically disposed at the vertices of a regular hexagon.

12. Tip according to claim 1, in which said projections (62) are so-called transverse projections (66), said transverse projections (66) being disposed in a plurality of n transverse planes which are typically perpendicular to said axial direction, in which case n varies from 5 to 20 and preferably from 8 to 15.

13. Tip according to claim 12, in which said transverse projections (66) are so-called circular projections (66′), each circular projection (66′) defining a typically flexible circular tongue which extends over 360°.

14. Tip according to claim 12, in which each transverse projection (66) of a same transverse plane typically comprises a plurality of n′ projections (66″) which are typically symmetrical with respect to said axial direction (10), in which n′ is between 3 and 6, and is typically equal to 4.

15. Tip according to claim 14, in which each projection (66″) defines an angular sector of angle a smaller than 360°/n′.

16. Tip according to claim 8, in which said handle member (4,601) comprises two portions of different cross-section: a so-called lower portion (42) having a transverse cross-section which typically approaches that of said rod, and a so-called upper portion (43) having a reduced cross-section, in a manner to be adapted to be operatively associated with said rod (2) through its lower tubular end (230), typically by snapping or welding.

17. Process for manufacturing a tip according to claim 1, in which a blank (8) of said tip constituting a single-piece member is produced by injection or injection-compression molding, a blank (8) of said tip forming a single-piece member and comprising n arms (8) which are articulated with respect to a central part (81) comprising or constituting at least one hinge (82), in a manner to constitute said single-piece tip (6) by folding said arms (80), wherein n typically varies from 2 to 4.

18. Process according to claim 17, in which said central part (81) comprising or constituting at least one hinge (82), is located at said upper end of said handle member.

19. Process according to claim 17, in which said central part (81) comprising or defining at least one hinge (82), is located at said lower end (33) of said application means, and typically at the lower end (67) of the core (600) of said molded member (6).

20. Applicator (2) for cosmetic products, typically mascaras, comprising an applicator tip (1,1″) according to claim 1, said applicator (2) comprising a rod (20) typically having said axial direction (10), said rod (20) being fixedly connected, at its so-called lower end (23), to said applicator tip (1,1″), and at its so-called upped end (22, to a means of manual prehension (21).

21. Dispenser applicator (7) for cosmetic products, typically mascaras, comprising an applicator (2) according to claim 20 which is operatively associated with a container (70) adapted to contain said cosmetic product, said container (70) comprising a typically threaded neck (71), typically provided with a wiper, said typically exteriorly threaded neck (71) being operatively associated with said prehension means (21) constituting an interiorly threaded plus (21) to seal said neck (71).
